(19) United States
(12) Patent Application Publication
(10) Pub. No.: US 2003/0163408 A1
(43) Pub. Date: Aug. 28, 2003

(54) Computerized system and method for exchanging information between a buyer, seller, and lender

(76) Inventors: Stephen Polston, Excelsior, MN (US); Michael K. Ross, Eden Prairie, MN (US); Michelle Patrice Brevig, Hopkins, MN (US); Jeffrey Matthew Colville, Brooklyn Park, MN (US)

Correspondence Address: Beck & Tysver, P.L.L.C., Suite 100, 2900 Thomas Avenue S., Minneapolis, MN, 55416, US

(21) Appl. No.: 10/187,207

(22) Filed: Jul. 1, 2002

Related U.S. Application Data
(60) Provisional application No. 60/359,804, filed on Feb. 26, 2002.

(51) Int. Cl. G06F 17/60

(52) U.S. Cl. 705/37

(57) ABSTRACT

The present disclosure is directed to a computerized system and method for exchanging information between a buyer, a seller and lender. The present system and method permit a seller to enroll buyers and easily focus sales efforts at buyers who might not yet be ready to purchase. The system and method seamlessly integrate lenders, permitting lenders to participate earlier in the buying process. Also, the system and method help educate and develop buyers, and provide for more personalized contacts with the lender and the seller even during the earlier stages of the buying process. In one aspect, a computerized method for exchanging information between a buyer, seller and lender is disclosed. The computerized method shares buyer-specific information between the seller and the lender. The computerized system also generates item-information for the buyer based on the buyer-specific information. The computerized system also monitors buyer activity related to the item information. The seller and lender are able to focus their efforts based on this information. Also, the computerized system manages seller and lender contacts with the buyer.

### CROSS-REFERENCE TO CO-PENDING APPLICATION

This application claims the priority of earlier-filed co-pending U.S. Provisional Patent Application No. 60/359,804, filed Feb. 26, 2002, entitled “Home Buyer Contact Conversion System and Method.”

### BACKGROUND

The present disclosure relates to a computerized system and method for exchanging information between a buyer, a seller, and a lender. More particularly, the present disclosure relates to a computerized method for integrating the efforts of a seller and lender in making items available for sale to a buyer.

Real estate agents expend a great deal of time and efforts on developing prospective buyers and sellers. A larger number of home sales relates to a larger number of commissions for the agent. Real estate agents use buyer seminars, advertising, personal relationships, open houses, telemarketing, past clients, the Internet, and the like, to develop prospective clients. These client development efforts cost money and take time away from the process of buying or selling a home, which directly leads to commissions. Conventional wisdom, however, believes that increasing client development efforts will increase the number of prospective buyers and sellers that, in turn, will translate to higher commissions for the real estate agent. This is true to a point, but a real estate agent needs a more efficient way of converting client development efforts into commissions.

Research has demonstrated that an agent who already sells at least one to two million dollars in real estate per year has already reached the point of diminishing returns for client development efforts. In a typical process of selling a home, the real estate agent might get 25 to 30 contacts per month (some real estate agents may get 25 to 30 contacts per week) that are interested at some level in purchasing the home. As used here, a “contact” is a prospective buyer or seller who contacts the agent inquiring about information on a specific house. Some of these contacts may be merely curious about the homes that are currently for sale, but may be disinterested in buying the specific home or any home at this time. Others, perhaps as few as two contacts per month, will be serious buyers. Most agents will ignore the less serious contacts, meaning that those contacts are lost. Of the two serious buyers pursued by the agent, only one might become a client of the agent. The agent's client development efforts have reached the lost contacts, but the real estate agent must use different efforts to convert the lost contacts into clients.

Recent has been directed at the buying patterns of the lost contacts. For example, approximately fifty percent of an agent's contacts will purchase a home within the next twelve months. Also, the assignee tracked the buying process of 5000 homebuyers. The average homebuyer takes approximately six to nine months from their first contact with a real estate agent before they are ready to buy a home. Approximately 90 percent of the time between first contact and purchase was spent during a period labeled the education phase. The prospective buyer seeks information, shops for and compares homes, and builds confidence in the home buying process and home prices, and the like, during the education phase. During this phase, the average prospective buyer contacts seventeen agents. Accordingly, at least sixteen agents have lost the opportunity to sell a home to the buyer.

The research also included a survey of 1058 real estate agents. Based on that survey, the average agent spends only two to four weeks with a buyer prior to purchase of a home. This occurs typically after the education phase and is called the action phase. Only ten percent of an agent's contacts happen during the action phase, and ninety percent of an agent's contacts occur during the education phase. Accordingly, by not focusing on buyers in the education phase, agents lose about ninety percent of the contacts created their client development efforts.

Lenders, such as a loan officer, usually become involved in the process after the contact is ready to buy. At this point, the real estate agent can choose to work with one of several lenders with which the agent has a personal relationship. Lenders, like agents, typically earn a living through commissions from each loan they sell. A lender is more or less in limbo while the agent and buyer view homes and work together to make a purchase. In order to better secure an income, a lender should enter the home buying process at an earlier point, and preferably during the education phase.

Finally, buyers would be better served if they received the attention of sellers and lenders earlier in the home buying process. Buyers, through individual attention from the agent and the lenders, could speed up the education phase, and therefore be ready to buy if a desirable home becomes available early in the process. Through individual attention, the buyers specific questions could be answered and needs met to help create a more sophisticated and confident buyer, which is certainly a benefit in the home buying process.

A method of providing information to a buyer in the education phase exists in the prior art. In this method, the real estate agent takes information from a buyer regarding the buyer's preferences for purchasing a home and the buyer's contact information. The agent then provides this information to a lender. The lender will then certify the buyer based on the buyer's purchasing ability and forward the buyer's preferences and authorized price range to an administrator who manages a network of lenders. Based on this information, the administrator mails the buyer a listing of homes within the buyer's price range and matching the buyer's preferences. The administrator follows-up with the buyer, as do the agent and the lender. Contact is made typically in person, over the telephone, and through the mail. The administrator prompts the agent and lender to contact the buyer periodically by sending them a list of contact information that includes a suggestion as to which prospective buyer should be contacted by them at that time.

Typical real estate agent web sites of the prior art provide for real time home searches based on a set of input search criteria, and may provide answers to frequently asked questions, but the web sites function more as client development tools. Such sites do not typically provide meaningful interaction between a buyer and an agent, and such sites do not provide for meaningful follow-up from the agent. Furthermore, such sites may provide basic financing information, but are mainly operated from the perspective of the agent. No effort is made to integrate the lender, or to allow the lender and agent to monitor a buyer's activities while assisting with contact management of the potential buyers.

### SUMMARY

The present disclosure is directed to a computerized system and method for exchanging information between a buyer, a seller and lender. The present system and method permit a seller to enroll buyers and easily focus sales efforts at buyers who might not yet be ready to purchase. The system and method seamlessly integrate lenders, permitting lenders to participate earlier in the buying process. Also, the system and method help educate and develop buyers, and provide for more personalized contacts with the lender and the seller even during the earlier stages of the buying process.

In one aspect, a computerized method for exchanging information between a buyer, seller and lender is disclosed. The computerized method shares buyer-specific information between the seller and the lender. Such information can include buyer-specific preferences, and notes about and impressions of the buyer. The computerized system also generates item-information for the buyer based on the buyer-specific information. The item information can include a list of item meeting the buyer-specific preferences and a detailed description of each item on the list. The seller and lender work together to determine the buyer-specific information and to develop a range of items the buyer can afford. The computerized system also monitors buyer activity related to the item information. For example, the seller and lender are able to view, based on the buyer's use of the computerized system, what items have caught the interest of the buyer. The seller and lender are able to focus their efforts based on this information. Also, the computerized system manages seller and lender contacts with the buyer. For example, through a series of prompts, the seller and lender are alerted as to when to contact the buyer for follow-up based on information such as buyer's activity.

In another aspect, the computerized system includes a set of application program interfaces for exchanging information between a buyer, a seller, and a lender. The system includes a first interface that receives buyer identification information and buyer search criteria. The system also includes a second interface that receives the buyer identification information from the first interface and selectively activates or amends the buyer search criteria to generate an activated preference information. The system includes a third interface that provides the item information based on the activated preference information. Also, the system includes a fourth interface, often integrated within the first and second interfaces, that prompts the seller and the lender to contact the buyer based on activity related to buyer's use of the third interface.

In still another aspect, a program having a graphical user interface is disclosed. The program includes a first page, for example an Internet web page, adapted to receive buyer-specific information. The first page also provides a status on a first set of buyers, such as buyers that are working with a particular seller. The program also includes a second page adapted to provide buyer-specific information and amend personal search criteria for a second set of buyers, such as sellers that are working with a particular lender. In one example, at least one buyer is common to both the first and second sets. A third page is included that provides item information and receive user inputs, such as inputs from a buyer. The first and second pages are adapted to monitor the user inputs and provide prompts to contact the first and second sets of buyers.

The computerized system and method provide several advantages over the prior art, and some of these advantages are listed below. For example, buyer information can be easily input, amended and shared. Updates to item information can be provided more quickly. The seller and lender can monitor buyer activity. Also, the system and method help the seller and lender manage contacts with the buyer to help eliminate redundant communication and to move the buying process forward. Additional advantages are contemplated, and will become apparent in the description below.

### BRIEF DESCRIPTION OF THE DRAWINGS

FIG. 1 shows a block diagram of the general relationship created between a buyer, seller, and lender with the computerized system of the present disclosure.

FIG. 2 shows a schematic representation of a method for exchanging information within the relationship of FIG. 1.

FIG. 3 shows a schematic representation of an aspect of the method of FIG. 2.

FIG. 4 shows a schematic representation of another aspect of the method of FIG. 2.

FIG. 5 shows a block diagram of an example of the computerized system as it relates to the method shown in FIG. 3.

FIG. 6 shows a block diagram of an example of the computerized system as it relates to the method shown in FIG. 4.

FIG. 7 shows a schematic representation of still another aspect of the method of FIG. 2.

FIG. 8 shows a block diagram of an example of the computerized system as it relates to the method shown in FIG. 7.

FIG. 9 shows a schematic representation of still another aspect of the method of FIG. 2.

### DESCRIPTION OF THE EMBODIMENTS

This disclosure relates to a computerized system and method for exchanging information between a buyer, seller and lender. The disclosure, including the figures, describes the computerized system and method with reference to a few examples. For instance, one example describes a computerized system and method for use by a real estate agent, a loan officer, and a home purchaser. Other examples are contemplated such as use with a car salesperson, finance or leasing company, and prospective car purchaser. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

FIG. 1 shows a block diagram of a general relationship of the disclosure. A buyer 20, seller 22, and lender 24 are connected through a computerized system 26. The buyer 20 can include anyone generally interested in an item, regardless of whether that person or entity will actually acquire or own the item. Examples of a buyer can include an individual actually interested in acquiring the item to be sold, an individual merely curious about the item, a representative of an individual who is interested in acquiring the item to be sold, and so on. Similarly, the seller 22 in the context of this disclosure has broad meaning and can include anyone who furnishes the buyer with the opportunity to purchase the item. Examples of a seller can include the current owner of the item, a representative or agent of the owner such as a real estate agent, someone such as a buyer's representative, who provides the buyer with opportunity to purchase the item, or the like. A lender 24 is anyone who can provide access to funds, whether it is for debt or equity. Examples include banks, loan officers, venture capitalists, or the like. In one embodiment, the seller is a real estate agent, the buyer is an individual in the education phase or action phase of the home buying process working with the real estate agent, and the lender is a loan officer with a business relationship with the real estate agent. In this embodiment, the computerized system includes a set of personal computers operating a computer program over the Internet.

In one general form, the computerized system includes at least one graphical user interface with a display and an optional selection device such as a stylus, keyboard or a mouse, or the like. The computerized system includes a set of instructions and/or interfaces embodied on a computer readable medium for execution on a computer. One example is a computer program stored on a memory device, such as a hard drive or some form of programmable read only memory device, or a server connected to the Internet. Computers connected to the server can include personal computers, personal digital assistants, wireless telephones, and other devices with the capability of linking to a network and accessing the program.

In the relationship created by FIG. 1, the seller is able to correspond with the lender and share notes regarding the buyer. The buyer is able to contact the seller and lender, either to request information from each, or provide information to each. The lender can contact the buyer and the seller and share notes with the seller. Additionally, the seller and the lender can monitor the buyer's activity regarding the items. The system also helps manage communication between the seller, the lender, and the buyer.

In general, the system is able to manage multiple buyers. The seller will work with a first set of buyers, the lender with a second set of buyers, where one or more buyers are common to both sets. Similarly, the seller and lender can work with multiple lenders or sellers, respectively. In one example, however, the buyer only works with one seller and one lender, while the seller will work with one lender and multiple buyers.

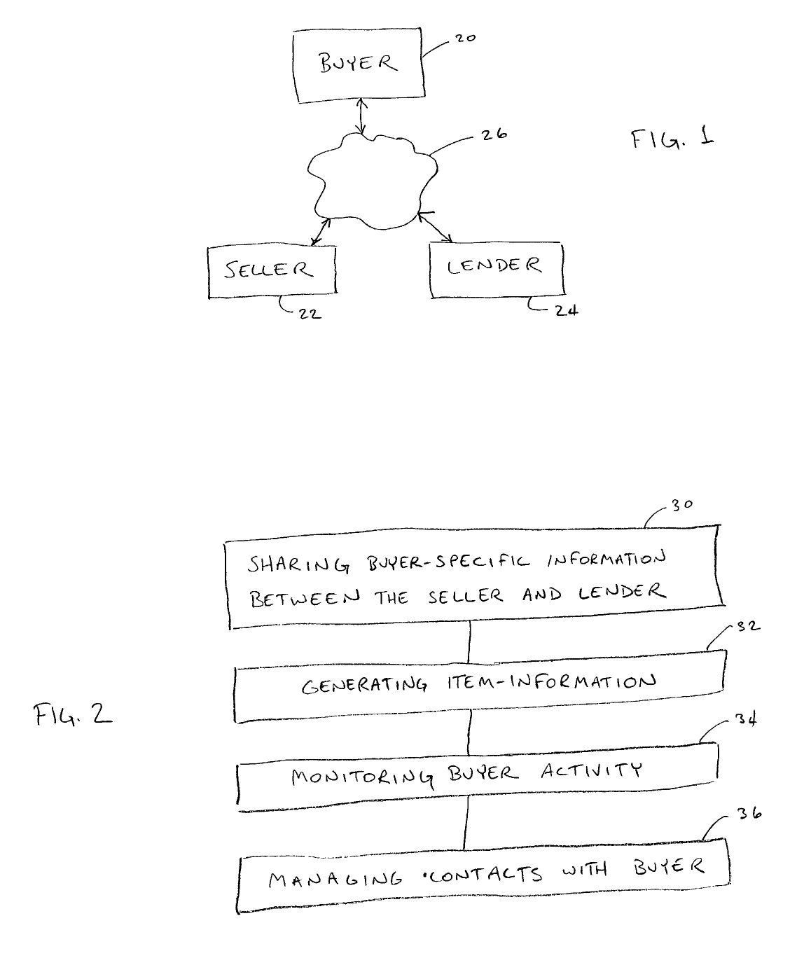

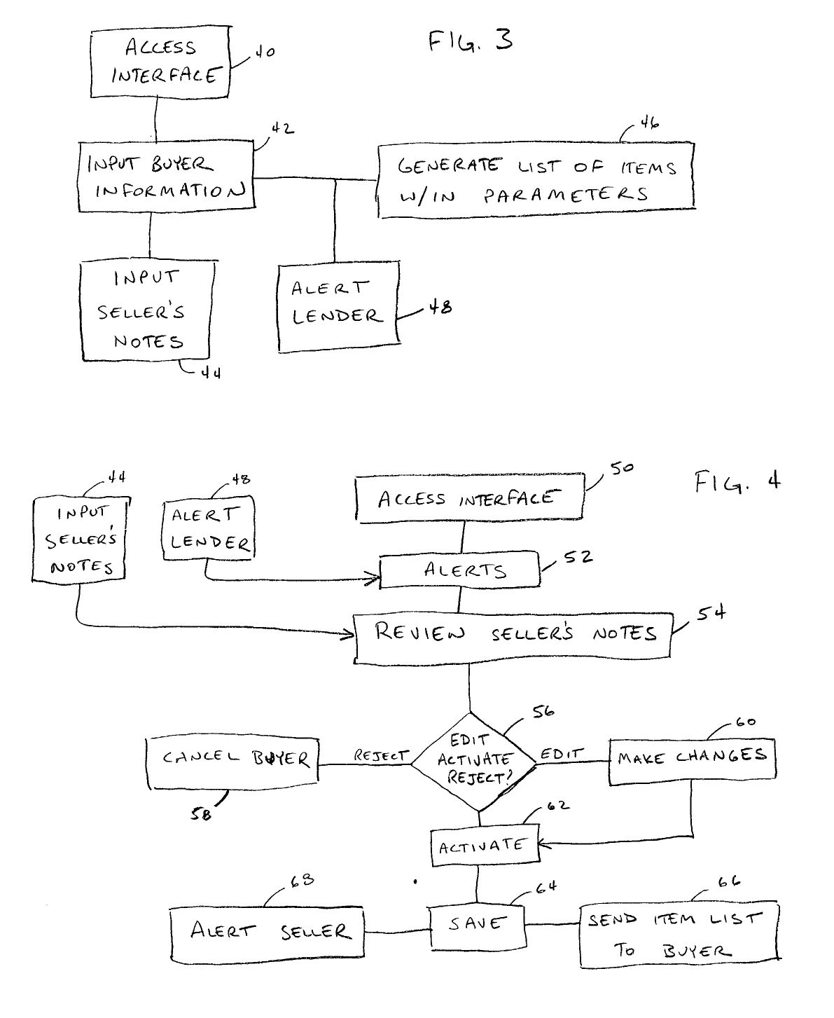

FIG. 2 shows a general view of the method for exchanging information between the buyer, seller and lender. Initially, the buyer 20 provides information related to the buyer 20 into the computerized system or to a seller or lender who provides this information into the computerized system. This information can include name or contact information and perhaps preferences regarding the item, and is otherwise referred to as “buyer-specific information.” As indicated at 30, at least some of the buyer specific information is shared between the seller and the lender. Based on this information, the computerized system can generate item-information, as indicated at 32. The item-information can include a list of items for sale, where the list can include detailed information about the item. The list can include information regarding a single item, or it can include no items if no items are found based on the buyer-specific information. The seller and lender are able to electrically monitor, or track, follow or note, at least some of the buyer's use of the item information, or activity related to the item information, at 34. The seller and lender are able to follow-up with the buyer with the computerized system. The computerized system manages seller and lender contacts with the buyer, 36. For example, the seller and lender are each given prompts from time to time to contact the buyer. The seller and lender are able to review buyer activity, or lack of activity, and contact the buyer to provide additional help or guidance.

In one embodiment, the buyer may be someone interested in purchasing a home, the seller may be a real estate agent, and the lender is a loan officer. The buyer provides the seller with background information about the buyer, such as the type of home the buyer is seeking. The lender receives financial information from the buyer to help determine a preferred price range for the type of home. A list of homes is generated and provided to the buyer who may then review the homes and save some of the list entries to a cache. The seller and lender are able to review the buyer's activity regarding the list and cache. The computerized system will notify the seller and lender through a series of prompts to contact the buyer. This embodiment is described in detail below.

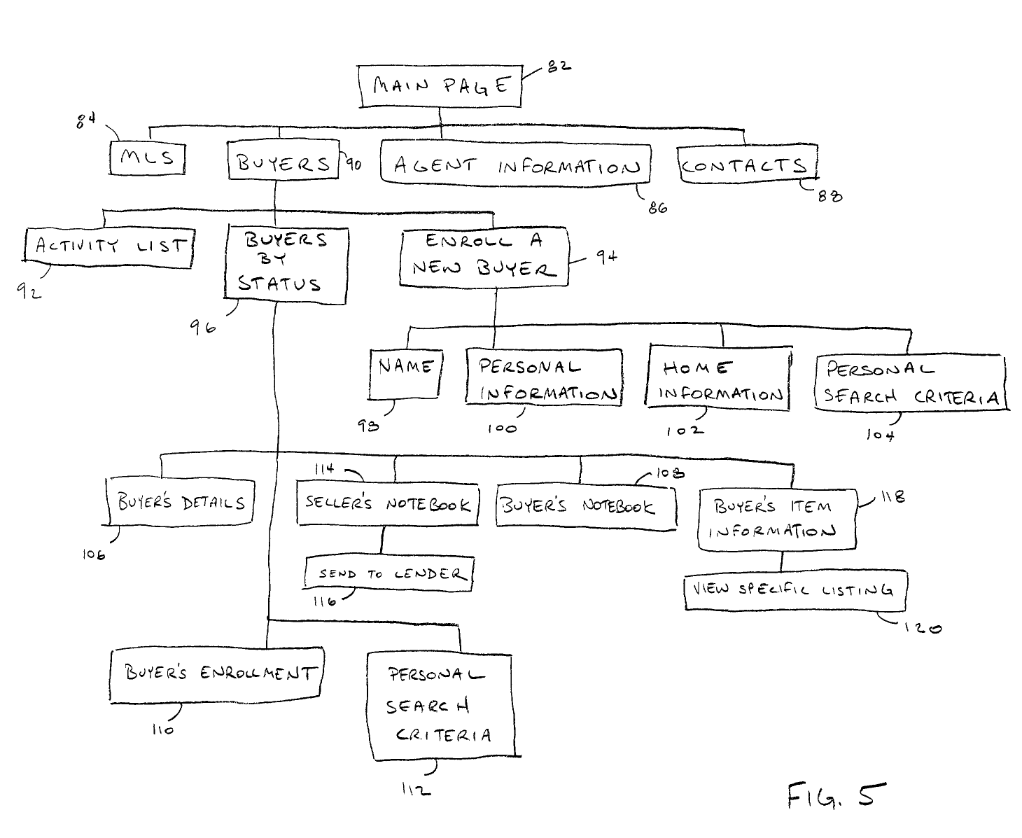

FIG. 3 shows a more detailed schematic representation of an embodiment of the method of the computerized system for exchanging information described above. More specifically, FIG. 3 shows a method of enrolling the buyer into the computerized system. In one application of the embodiment shown, the buyer first makes contact with the seller, and the seller will initially input some buyer-specific information. To do this, the seller will access a first interface, 40, of Seller's interface. To do this, the seller will access the computerized system, which can then prompt the seller to access a specific interface. In one application, the seller will access the program, with a web browser, at a specific Internet address. The program prompts the user of the site to log-on to password-protected pages for each of the seller, lender and buyer. For example, a page welcomes the user to enter the site as a seller, lender, or buyer. After the user's proper role is selected, another page requests login identification and a user-specific password. An authorized seller will log-in and the computerized system will display the seller's main page.

From the seller's main page, the seller can follow a link or links to a page, 42, that will allow the seller to enroll a new buyer by entering buyer-specific information that includes search criteria. The search criteria allow the system 26 to sort through all of the items in its database to identify items that may be of interest to the buyer. In the real-estate embodiment of the present invention, the buyer-specific information can include fields such as the buyer's name, address (including e-mail address), type of property the buyer is interested in purchasing, whether the buyer currently owns a home, minimum and maximum search price, minimum number of bedrooms and bathrooms, zip code or neighborhood description of the location of the property, and the like. Additional buyer-specific information may include target move-in date to alert the seller to when the buyer gets closer to the action phase of purchase, and more detailed information about the property such as lot size, pool, or the like. Once completed the seller may save the information and complete the enrollment. Additionally, the seller can also add notes regarding the buyer that can be saved and later viewed by the seller and lender, 44.

After enrollment is complete, a list of available properties is displayed to the seller, 46, and the program alerts the lender of a new enrollment, 48. This list includes the available properties that fall within the buyer search criteria of the buyer-specific information. If no available properties, or an inadequate number of properties are available, the seller can amend the buyer-specific information to yield a better result. In one example, the list includes a page with general descriptions of the properties where each description is linked to a detailed description of the property that may include one or more photographs. In this example, the list is not sent to the buyer until the lender can certify the buyer's price range. Accordingly, when the lender is sent the alert, 46, the program prompts the lender to contact the buyer.

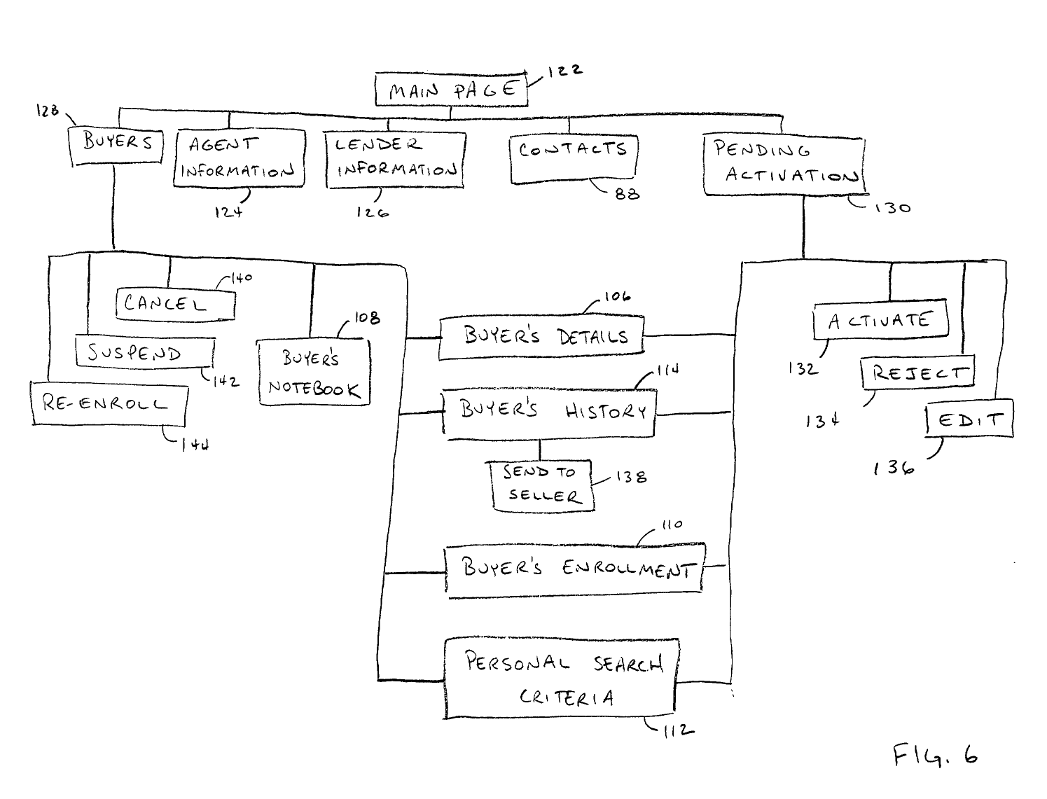

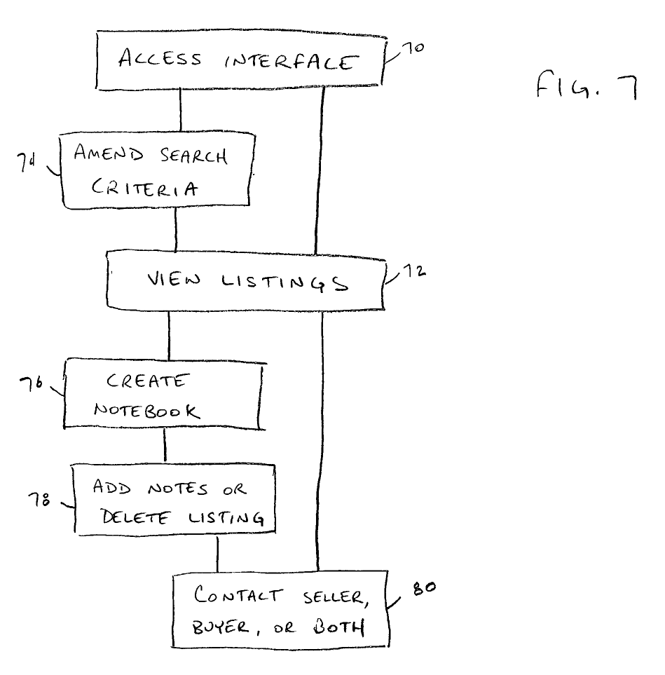

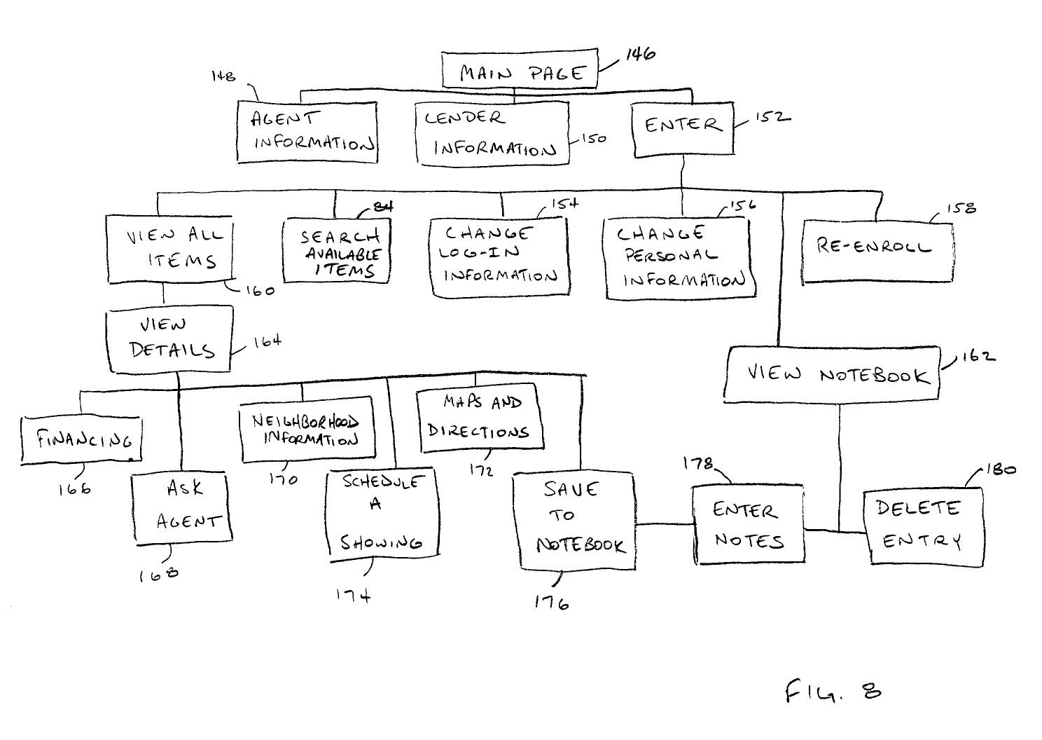

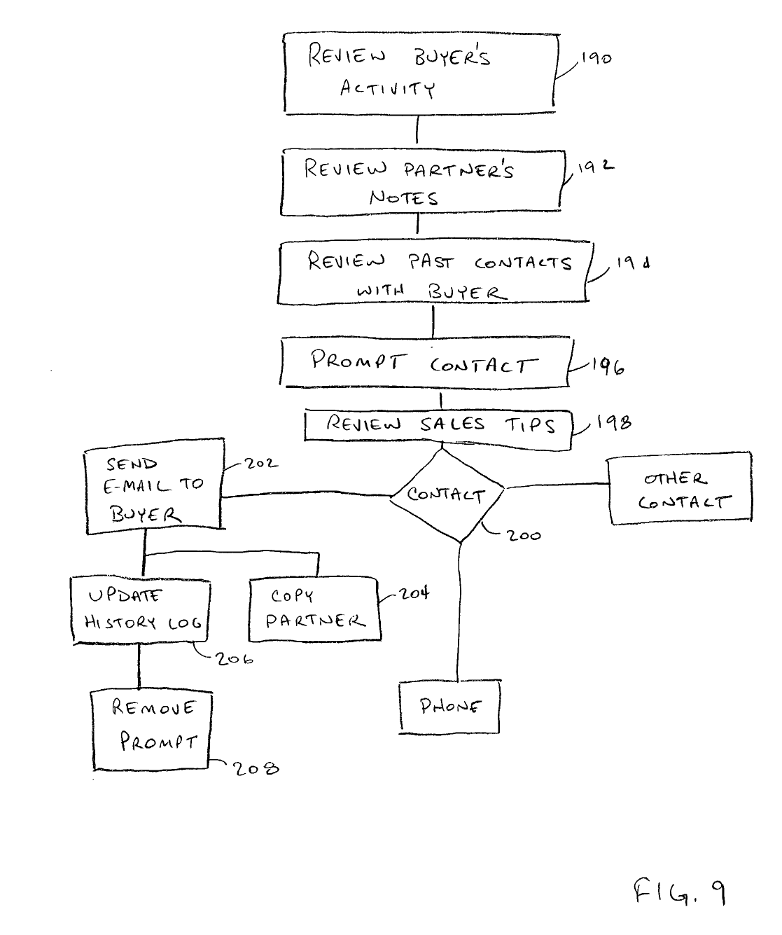

FIG. 4 shows a schematic representation of activating the buyer using a lender interface to the computerized system, 26. In the preferred embodiment, the lender accesses a password-protected web page in a manner similar to that described in connection with FIG. 3. The lender enters web site as the lender and is directed to the lender's main page. In the example described, the lender's main page will alert the lender is there are any new buyers that are pending activation, 52. A list of such buyers will appear, together with the buyer's corresponding seller. Alternatives to this example are contemplated. In the example, each buyer in the list of buyers awaiting activation will contain a link to a page where the lender can continue activating a selected buyer.

In the example, the link will access a page that includes buyer-specific information and the seller's notes regarding the buyer, 54. Based on this information and any other contact with the buyer or amendments to the buyer-specific information, the seller can then select whether to reject, amend or activate the buyer, 56. This decision can be based on financial information, price range, or both. If the buyer is financially unable to purchase at this time, the lender can cancel the buyer, 58, and eliminate the buyer from the system or simply leave the buyer pending, for example until financial issues are resolved. The lender can also amend the search criteria with the buyer, 60, such as raising or lowering the maximum price of the item based on the buyer's financial information, and then activate the buyer, 62. Additionally, the lender can simply activate the buyer without amendment, 62. During this process, the lender can create notes regarding the buyer that the lender can save for future reference. The lender's notes will become accessible to the seller. The lender then saves the activation 64.

After the buyer is activated, the buyer is notified and the list of items related to the search criteria is made available to the buyer, 66. The list of items generated 66 may differ from the original list of items 46 depending on whether changes were made to the buyer-specific information or any updates. One example of notification is an e-mail automatically sent from the seller to the buyer including a welcome message and as well as information on how to access a password-protected interface with item information. A notice also is sent to the seller that the buyer is now activated 68 and the list of items and amended buyer-specific information, along with the lender's notes about the buyer, are made available to the seller.

FIG. 5 shows a block diagram of a specific example of the computerized system as it relates to the seller's interface. The seller accesses the main page 82 after logging into the seller's site. The main page contains a link to a search by the Multiple Listing Service, or MLS, 84, to find a specific property by MLS number or address. The main page 82 also contains a link to agent information 86 that allows the seller to change information about the seller, include a photograph, or the like, that can be viewed by the lender and buyer. A link to contacts 88 allows the seller to access technical help related to the computerized system 26. The seller also access information regarding previous, existing or new buyers from the buyers link 90.

The buyers link 90 permits the seller to view buyers' activities 92 over the computerized system, to enroll a new buyer 94, and see all information regarding the buyer 96. To enroll a new buyer 94, as described above, the seller enters a series a fields for each of buyer's name and contact information 98, personal information about the buyer 100, information regarding the buyer's existing home 102, and personal search criteria 104. From the buyer's status link 96, the seller is able to sort enrolled buyers by category and view detailed information about each buyer. Categories of buyers include active, pending, recently expired, or the like, and combinations of two or more categories. From a listing of buyers, the seller can access a page for a specific buyer. From each buyer page, the seller can access detail about the buyer 106, the buyer's note book 108 (described in detail below), the buyer's enrollment information 110, the personal search criteria 112, the seller's note book 114, which can be sent electronically to the lender 116. The seller can also access the buyer's list of items 118 and view each listing and the buyer's activity regarding each 120.

FIG. 6 shows a block diagram of a specific example of the computerized system as it relates to the lender's interface. The lender accesses the main page 122 after logging into the lender's site. The lender can access information regarding the agent or agents working with the lender 124. The lender can also create or amend lender information 126 that contains the information about the lender that will be viewed by sellers or buyers accessing the computerized system 26. The link to contacts 88 allows the lender to access technical help. The main page 122 also provides the lender a link to information regarding the buyers in the system 128, and buyers that are pending activation 130. In the example shown, the lender's link to buyers 128 differs from the seller's link to buyers 90 in that not all of the seller's information regarding a buyer is available to the lender. Of course, the disclosure contemplates an example where all information is shared between the seller and lender.

The lender may activate 132, reject 134, or edit 136 the buyer pending activation through the pending activation link 130. Often, the lender will review buyer information such as the buyer's detail page 106, buyer's enrollment page 110, and the personal search criteria 112. The lender can review the seller's notes 114, add notes and send the added note to the seller 138.

The lender can also access the files on buyers that have been activated from the buyers' link at 128. For each activated buyer, the lender can select whether to cancel 140, suspend 142 or re-enroll 144 the buyer, if the system permits only a limited enrollment period, or if the buyer-specific information has changed. The lender can also access the buyer's notebook 108, along with additional pages regarding the buyer.

FIG. 7 shows a schematic representation of computerized method as it relates to the third interface, or buyer's interface. The buyer is able to access the third interface from the same web site as the seller and lender. The buyer selects a link to the third interface and then enters password and user name information provided to the buyer in the welcome e-mail from the seller. Some items for sale may have related legal requirements in certain jurisdiction that must be satisfied. For example, some jurisdictions have a specific Buyer-Agency Disclosure notice that should be acknowledged by the buyer regarding the sale of real estate. In one example of the computerized method, a buyer accessing the site for the first time will be subjected to this notice. The buyer then accesses the buyer's main page 70. From the main page 70, the buyer can access the list of items, 72. Additionally, the buyer can amend the search criteria, 74, and then view an amended list of items. The buyer is not able to unilaterally amend all fields of the search criteria. For example, the buyer is not able to amend a field related to maximum price after activation without consultation with the lender. Other fields, such as number of bathrooms or neighborhood are subject to amendment.

The buyer is able to create a buyer's notebook 76 containing a subset of the items shown on the list of items, 72. The buyer will use the notebook to store information about items or properties that are of interest to the buyer. Additionally, it is contemplated that the buyer can create several notebooks to store more than one subset of the items. The buyer can add personal notes to any item in the notebook, or delete a listing from the notebook, 78. The seller and lender are able to review the notebook, including the buyer's notes.

Each item in the list of items 72 can include a link to more detailed information regarding the item. This detailed information can include a photograph of the item or maps and direction to the property or neighborhood information if the item is real estate, for example. From this list 72, the buyer can also contact the agent or lender via e-mail, or request a showing of the property or item, 80.

FIG. 8 shows a block diagram of a specific example of the computerized system as it relates to the buyer's interface. The buyer accesses the main page 146 after logging into the buyer's site. The buyer can access information regarding the agent 148 or lender 150 working with the buyer, or can enter the site to view items, or properties, 152. The buyer is able to access pages that will perform administrative tasks like search the available items 84, change log in information 154, change personal search criteria 156 or request re-enrollment 158. Additionally, the buyer can view all listings 160 or view listings saved into a notebook 162. From the view all listings link 160, the buyer can view details about a particular listing 164. While viewing the details, the buyer can electronically receive information about financing 166, contact the seller via e-mail 168, get information regarding the neighborhood of the property 170, get maps and directions to the property 172, and schedule a showing of the property 174. Also, the buyer can save the particular property to a notebook 176 and enter notes regarding the property 178. The buyer is able to view the details of listings in the notebook, 162, rather than all of the listings. Once in the notebook 162, the buyer can enter notes 178 or delete the entry from the notebook 180, in addition to other functions.

FIG. 9 shows a schematic diagram of a method to manage contacts from the seller or lender to the buyer. At this point, the seller and lender are considered partners for the purposes of discussion, although rarely is a legal partnership created. Each partner will access their respective main pages and follow the links to a specific buyer. Each partner will review the buyer' activity 190, e.g., whether the buyer has accessed the listing, created a notebook, added notes, or the like, Each partner will also review notes of the other partner 192 as well as notes that they have made regarding previous contacts with the buyer, 194. The system will notify one of the partners when to make a contact with the buyer by providing a prompt to one of the partners 196. In one example, the system will provide a list of sales tips 198 to aid the partner in making an effective contact with the buyer. The partner responsible for the contact can choose how to make the contact 200, e.g., by phone, in person, or by e-mail. If the contact is made by e-mail 202, the sender of the e-mail can choose to copy the partner on note to the buyer 204. The system automatically updates the history log 206 and save the e-mail for future reference. Once updated, the system automatically removes the prompt 208.

Managing contacts can be provided by a forth interface of the program, although the seller and lender need not access a dedicated web site. Managing contacts can be integrated into the seller's and lender's interfaces. In one example of managing contacts, a prompt will be indicated as a dot next to a buyer's name on the list of buyers for each partner. The partner receives the prompt to make the contact will see one color of the dot by the buyer's name. The other partner will see a dot of a different color indicating that the first partner must make the contact. For example, the first color can be black, where the other color can be grey. Once the partner who is responsible for contacting the buyer has made the contact, the system will indicate that by placing a check within the dot on each partner's listing.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents.

What is claimed is:

1. A computerized method for exchanging information between a buyer, a seller and a lender, the computerized method comprising:
sharing buyer-specific information between the seller and the lender;
generating item-information for the buyer based on the buyer-specific information;
monitoring buyer activity related to item-information; and
managing seller and lender contacts with the buyer.

2. The computerized method of claim 1 wherein the sharing of buyer-specific information between the seller and the lender includes sharing information provided by the buyer and sharing information provided by the seller and the lender.

3. The computerized method of claim 2 wherein the sharing of information provided by the seller and lender includes sharing notes provided by the seller and lender.

4. The computerized method of claim 1 wherein the generating of item-information for the buyer includes providing item information to the buyer and the seller.

5. The computerized method of claim 4 wherein the generating of item information for the buyer includes generating a list of at least one items related to the buyer-specific information and generating detailed-information regarding each item on the list.

6. The computerized method of claim 1 wherein the monitoring of buyer activity includes providing information regarding the buyer's use of the item-information to the seller and lender.

7. The computerized method of claim 6 wherein the managing of seller and lender contacts is related to past contacts of the seller and lender with the buyer and buyer activity related to the item-information.

8. A set of application program interfaces embodied on a computer readable medium for execution on a computer in conjunction with an application program for exchanging information between a buyer, a seller and a lender, comprising:
a first interface that receives buyer identification information and buyer search criteria;
a second interface that receives the buyer identification information from the first interface and selectively activates or amends the buyer search criteria to generate an activated preference information;
a third interface that provides item information based on the activated preference information; and
a fourth interface that prompts seller and lender contacts with the buyer based on activity related to the item information.

9. The set of application program interfaces of claim 8 wherein the second interface receives buyer financial information and amends the personal search criteria.

10. The set of application program interfaces of claim 8 wherein the first interface and third interface provide item information.

11. The set of application program interfaces of claim 8 wherein the fourth interface is integral to the first and second interfaces.

12. A program having a graphical user interface for use with a computerized system having a display and a selection device, the program adapted to exchange information between a buyer, a seller and a lender, the graphical user interface comprising:
a first page adapted to receive buyer-specific information including personal search criteria, and the page adapted to provide status on a first set of buyers, the first set of buyers comprising at least one buyer, the status including item information for each of the buyers in the first set of buyers;
a second page adapted to provide buyer-specific information and amend personal search criteria, and the page adapted to generate item information on a second set of buyers, wherein the at least one of the buyers in the first set of buyers is common to the second set of buyers;
a third page adapted to provide item information and receive user inputs;
wherein the first and second pages are adapted to monitor the user inputs; and
wherein the first and second pages are adapted to provide prompts to contact the first and second sets of buyers.

13. The graphical user interface of claim 12 wherein the first page is accessible only by the seller, the second page is accessible only by the lender, and the third page is accessible only by the buyer.

14. The graphical user interface of claim 12 wherein the first page provides access to a link to enroll a new buyer, and a link to check on the status of activated buyers.

15. The graphical user interface of claim 12 wherein the second page includes access to a link to one of activate, reject, or amend a the new buyer, and access to a link to cancel, suspend, or re-enroll activated buyers.

16. The graphical user interface of claim 12 wherein the third page includes a link to provide detailed item information, and to enter notes regarding the detailed item information.

17. The graphical user interface of claim 16 wherein the first and second page are adapted to provide the notes regarding the detailed item information.

18. The graphical user interface of claim 12 wherein the prompts include a first prompt sent to one of the first page and the second page, and a second prompt sent to the other of the first page and the second page.
